(19) United States
(12) Patent Application Publication
(10) Pub. No.: US 2026/0208881 A1
(43) Pub. Date: Jul. 23, 2026

(54) FLIGHT CONTROL SURFACE DROOP PREVENTION CLIP

(71) Applicant: Government of the United States as represented by the Secretary of the Air Force, Wright-Patterson AFB, OH (US)

(72) Inventors: Alexander Dunigan, Luke AFB, AZ (US); Devin Humphreys, Luke AFB, AZ (US)

(21) Appl. No.: 19/035,247

(22) Filed: Jan. 23, 2025

(51) Int. Cl. B64F 5/40; F16B 2/20

(52) U.S. Cl. CPC B64F 5/40; F16B 2/20

(57) ABSTRACT

A clip for preventing droop of aircraft flight control surfaces when hydraulic fluid is removed. The clip has longitudinally opposed notches. One notch receives an edge of a wing while the other notch receives an opposed edge of the flight control surface. The clip resists downward articulation of the flight control surface due to gravity, by applying a bending moment against the wing. The clip is frictionally held in place. The clip may be symmetric about all three perpendicular axes and composed of three interlocking pieces.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a clip for preventing droop of aircraft flight control surfaces, more particularly to such a clip which has no moving parts and requires no external power supply, more particularly to such a clip which can be attached to and removed from the aircraft and more particularly to such a clip which can be attached to and removed from the aircraft without hand tools such as a wrench, screwdriver, socket or pliers.

### BACKGROUND OF THE INVENTION

Airplane wings date back to the Wright brothers. The wings of an airplane provide lift, acting against the force of gravity. Lift is produced by the cross-sectional shape of the wings. As the wing moves forward through the air, the wing splits the airstream into two parts, one stream going over the wing and the other stream going under the wing. The two air streams flow at different velocities, creating a pressure differential between the upper and lower surfaces of the wing due to an effect explained by Bernoulli's Principle. The wing is typically rounded and thick at the front, or leading, edge, and tapered to a point at the back, or trailing, edge.

Wing modifications began to occur soon after the Wright Brothers, with various attempts to change the wing geometry during flight. For example, US Patent 1024928 filed in 1908, US Patent 1024929 filed in 1909 and US Patent 1098131 filed in 1912 all are directed to changing the configuration of the wings. Hinged flaps date back to at least US Patent 1422616, filed in 1921. The National Advisory Committee for Aeronautics (NACA) was founded in 1915 and transformed into the National Aeronautics and Space Administration in 1958. Throughout the tenure of the NACA, significant research went into wing design, including airfoils, flaps, ailerons and the like, collectively referred to as flight control surfaces.

Referring to FIG. 1, the contemporary aircraft 20 has a central fuselage 24 with two outwardly extending wings 21. The wings 21 carry one or more engines and have various flight control surfaces 25. The aircraft 20 has a cockpit 22 at the forward end thereof an opposed tail 23 at the aft end.

Today's aircraft wing 21 is a sophisticated structure with both internally stationary and externally movable features. While the primary purpose of a wing 21 is to produce lift, it also aids in structural stability, maneuverability, and fuel storage.

Referring to FIG. 2, the wing 21 extends outwardly from a proximal end connected to the fuselage 24 to a distal end remote therefrom. The wing 21 has a leading edge and trailing edge. The leading edge is the front of the airfoil and the portion that meets the air first. The trailing edge is the back of the airfoil the place at which the airflow over the upper surface of the airfoil joins the airflow over the lower surface of the airfoil. The chord of an airfoil is a straight line drawn through the airfoil from its leading edge to its trailing edge. The camber of an airfoil is the curve of its upper and lower surfaces. This curve is measured by departure from the chord of the airfoil. The upper camber refers to the camber of the upper surface of the airfoil. The lower camber refers to the camber of the lower surface of the airfoil. The camber of a wing 21 affects lift. Trailing edges of wings 21 have flaps whereas leading edges have slats. Aircraft wings 21 are designed to optimize overall performance at various stages within the flight envelope.

As viewed along the longitudinal axis of the fuselage 24, wings 21 can form a dihedral or anhedral angle with a reference plane at the fuselage 24. A dihedral angle is the upward angle that the wings 21 make relative to a reference axis for the aircraft 20. One purpose of using dihedral is to improve the aircraft 20 lateral (roll) stability. The horizontal tail 23 may also have some dihedral, especially on larger aircraft 20, contributing to lateral stability. An anhedral wing 21 angle is downward from the fuselage 24 and typically used with a wing 21 sweepback or a high wing design due to decreased roll stability. Aircraft 20 with swept wings 21 may use anhedral to offset the increase in roll stability from the sweepback. Aircraft 20 with high-mounted wings 21 tend to have pendular lateral stability because the center of gravity lies below the center of the lift which is the aerodynamic pivot point. Anhedral on the wing 21 is helpful so that the lateral stability does not make the aircraft 20 difficult to maneuver.

Referring to FIG. 3, wings 21 comprise several significant components on the outside, including flaps, slats, ailerons, spoilers, and winglets. Flaps are high-lifting devices installed on the leading and trailing edges of the wings. Flaps are also retractable panels located along the trailing edge of the wing used to increase lift and drag during takeoff and landing. When the flaps are extended, the wing 21 surface area increases, providing more lift and slowing the aircraft 20 down for landing. Trailing edge flaps increase the wing 21 surface area and provide more camber. Since the lift coefficient is a function of the wing 21 area, lift is substantially increased when the trailing edge flaps are deployed. In some wing 21 configurations, leading-edge flaps are also known as slats, mostly found on large commercial aircraft wings.

Ailerons are located at the trailing edge of each wing 21 and are used to control the roll of the aircraft 20. Ailerons are flat rectangular sections located near the wingtips on the wing 21 trailing edge. Ailerons move up and down to change the airflow passing over the wing 21. When the aileron on one side is deflected upward, the opposite side goes downward. A pilot will raise the left aileron and lower the right when rolling to the left. Ailerons thus produce adverse yaw.

Spoilers are larger rectangular panels in the middle of the wing 21 upper surface. Spoilers are retractable panels located on the upper surface of the wings 21 and are used to reduce lift and increase drag. They are activated to slow the aircraft 20 and to aid in descending during landing and tactical operations. Spoilers reduce the lift on the wing 21 surface and increase drag, aiding in both landing and rolling. Deploying spoilers on only one wing 21 helps roll or turn an aircraft 20. When spoilers are simultaneously deployed on both wings 21 the aircraft 20 slows for landing.

Winglets are stationary tabs on the distal ends of the wings and improve aircraft 20 performance by managing the pressure distribution between the higher-pressure side of the wing 21 and the lower-pressure side. Winglets minimize the effects of wingtip vortices through the partial recovery of the tip vortex energy. Winglets can improve fuel efficiency.

Flaps, slats, ailerons, spoilers are hingedly articulable to either lie within the plane of the wing 21 or articulate about a proximal end to raise or lower the distal end thereof above or below the wing 21. Such flaps, slats, ailerons, spoilers are collectively referred to herein as flight control surfaces 25. The flight control surfaces 25 can be articulated by the pilot from a neutral position aligned with the wing 21 to an activated position above or below the wing 21 as needed.

The movable, articulable flight control surfaces 25 are usually controlled by pressurized hydraulic systems. Typical components of the aircraft 20 hydraulic system include a reservoir, pump, actuators, valves, tubes, hoses, and filters. Aircraft 20 typically have redundancy such as dual engine driven hydraulic pumps or dual electric hydraulic pumps to provide redundancy of the critical hydraulic functions for plane operation. Electrohydrostatic actuation systems control then the hydraulics. Proper and frequent maintenance of the hydraulic system is critical. Hydraulic fluid must be drained and replaced. Hydraulic system components no longer pressurized and can be inspected and restored as needed. But when the hydraulic fluid is drained, flight control surfaces 25 droop.

Droop occurs when the flight control surface 25 articulates under the influence of gravity to a downward position. The flight control surface 25 is then below the elevation of the wing. This droop interferes with maintenance, such as inspection and removal of adjacent panels. Furthermore, injury can occur when personal unintentionally contact or bump drooped flight control surfaces 25. Severe impact may require repair or replacement of the flight control surfaces 25.

Despite more than 100 years of wings 21 having flight control surfaces 25 which droop, a satisfactory solution to remedy, or even mitigate, the droop remains elusive. Personnel must work around the drooped flight control surfaces 25, increasing maintenance costs and the potential for injury.

Accordingly, it is an object of this invention to provide a solution to the problem of drooping flight control surfaces 25. Particularly, it is an object of this invention to provide a solution which stabilizes flight control surfaces 25 in a neutral position substantially aligned with the wing 21 to prevent drooping. More particularly it is an object of this invention to provide a solution to drooping flight control surfaces 25, the solution having no moving parts which may interfere with other maintenance operations, no external power requirement, is unobtrusive to not displace other workers, does not require hand tools and is compact for storage and quick deployment.

### SUMMARY OF THE INVENTION

In one embodiment the invention comprises a clip for holding a flight control surface in an upright position, the clip defining mutually perpendicular longitudinal, transverse and lateral axes. The clip comprises: a spine having mutually opposed faces a longitudinal axis with mutually opposed and longitudinally spaced distal ends; mutually opposed notches with each distal end having a notch therein, each notch intercepting a respective distal end and extending from the first face to the second space and a bowtie intermediate and separating the longitudinally opposed notches.

In one embodiment the invention comprises a multi-part clip for holding a flight control surface in an upright position, the clip defining mutually perpendicular longitudinal, transverse and lateral axes. The clip comprises: a spine having mutually opposed faces a longitudinal axis with mutually opposed and longitudinally spaced distal ends and; mutually opposed notches with each distal end having a notch therein, each notch intercepting a respective distal end and extending from the first face to the second space and a bowtie intermediate and separating the longitudinally opposed notches, the clip being easily separable into plural distinct parts.

In one embodiment the invention comprises a kit for temporarily aligning a flight control surface on a wing of an aircraft. The kit comprises: first and second mutually identical clevises, each clevis comprising two legs extending outwardly from a proximal end to laterally spaced apart legs distal ends, defining respective longitudinally spaced apart clip distal ends, each clevis having a laterally extending hole through at least one leg; a bowtie configured to be received into the legs of each clevis and juxtaposed with the proximal end the respective clevis and a pair of mutually identical pins, each pin having a shank sized to fit into the hole of a clevis and a head joined thereto sized to prevent insertion into the hole of a clevis.

### BRIEF DESCRIPTION OF THE DRAWINGS

All figures are to scale, except for FIGS. 9A and 9B which are schematic. FIG. 1 is an exploded perspective view of an aircraft. FIG. 2 is a cross-sectional view of an aircraft wing. FIG. 3 is a fragmentary perspective view of a wing showing the flight control surfaces.

FIG. 4A is a perspective view of a clip according to the present invention. FIG. 4B is an exploded perspective view of the clip of FIG. 4A. FIG. 5A is a front elevational view of the clip of FIG. 4A having the pins elevated for clarity.

FIG. 5B is an exploded front elevational view of the clip of FIG. 5A. FIG. 6A is a top plan view of the clip of FIG. 4A. FIG. 6B is an exploded top plan view of the clip of FIG. 6A.

FIG. 7A is a bottom plan view of the clip of FIG. 4A.

FIG. 7B is an exploded bottom plan view of the clip of FIG. 7A.

FIG. 8A is a profile elevational view of the clip of FIG. 4A.

FIG. 8B is an exploded profile elevational view of the clip of FIG. 8A.

FIG. 9A is a fragmentary top plan view of the clip in use on the wing of an aircraft.

FIG. 9B is a fragmentary sectional view of the wing and clip of FIG. 9A.

### DETAILED DESCRIPTION OF THE INVENTION

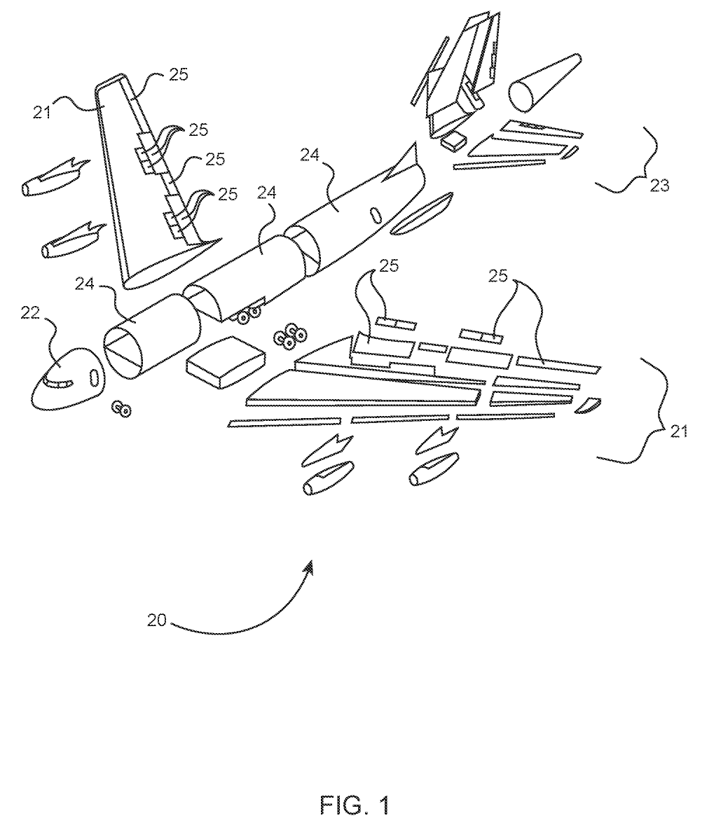

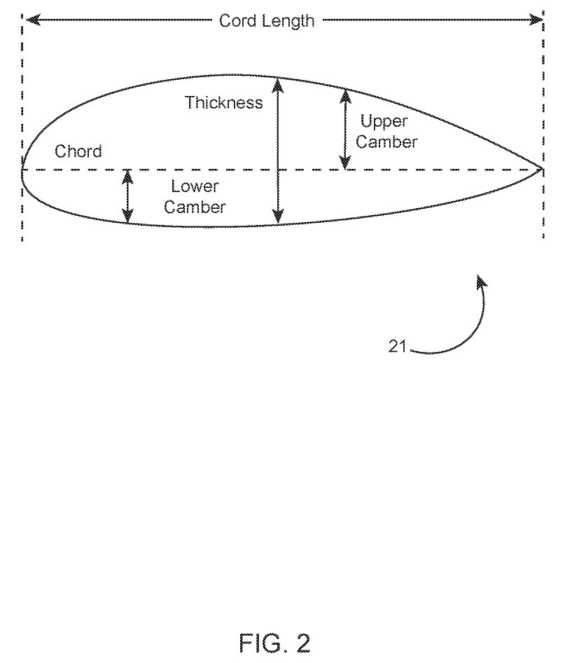

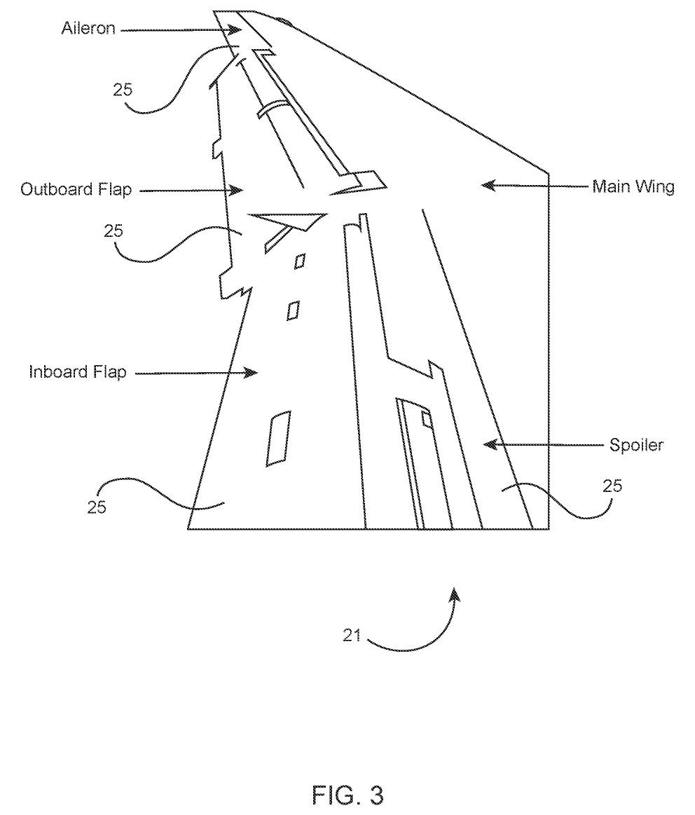

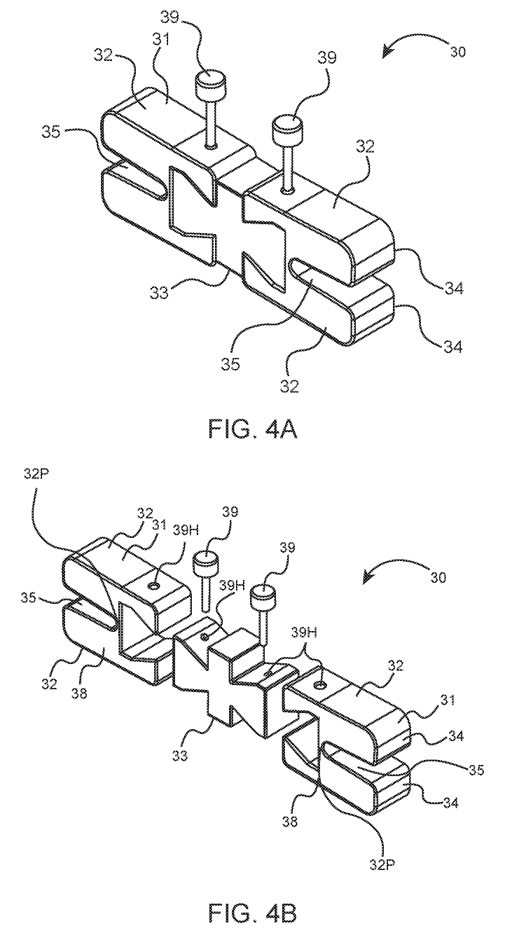

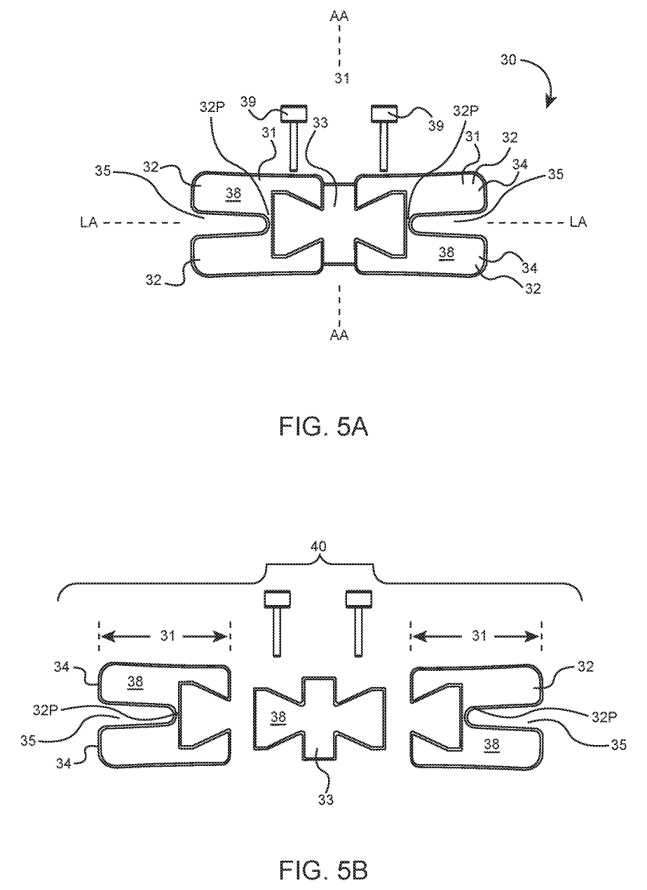

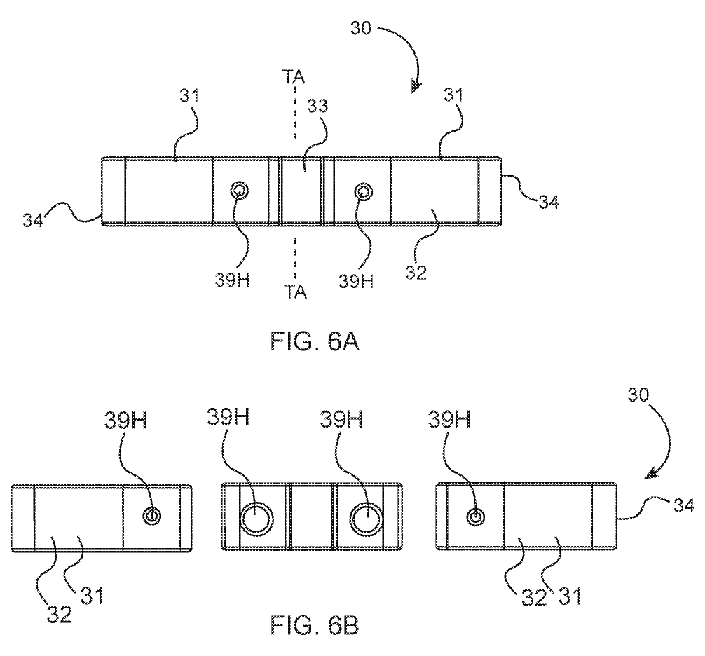

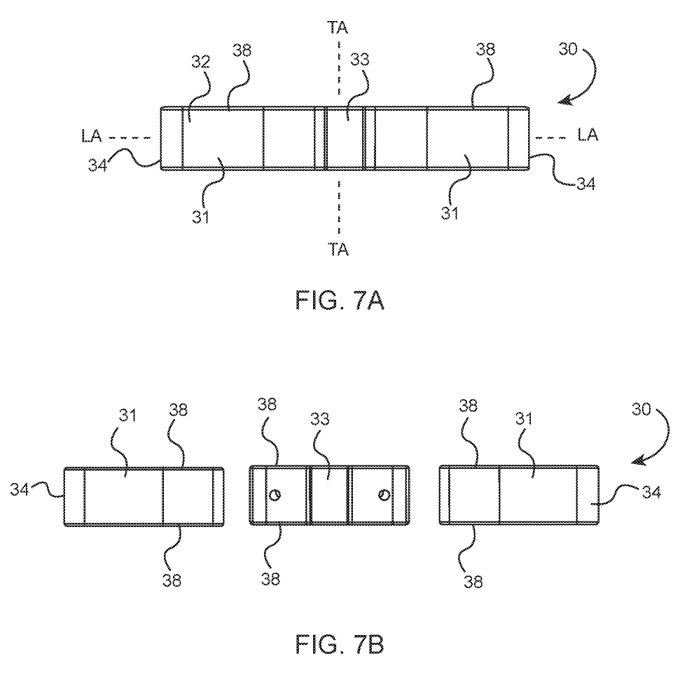

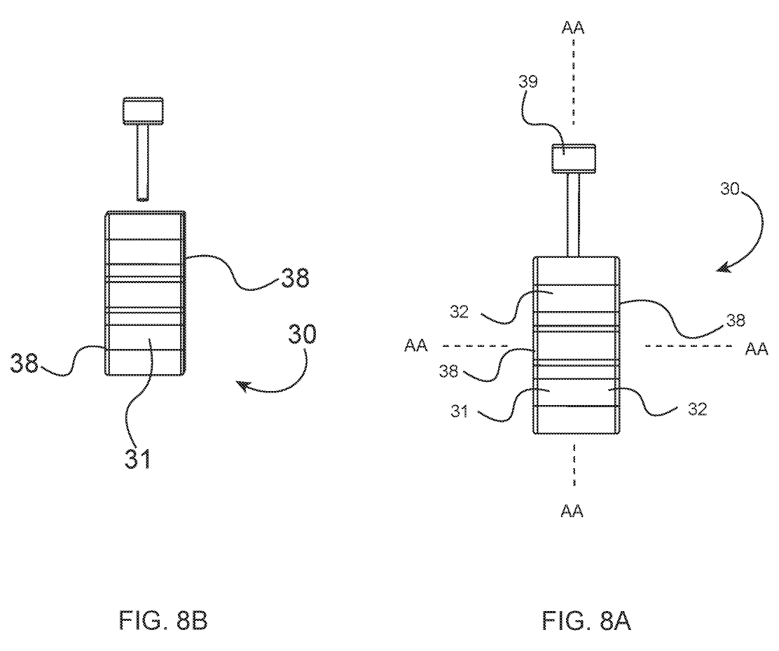

Referring to FIGS. 4A - 8, the invention comprises a clip 30 having a central bowtie 33 longitudinally flanked by a pair of outwardly extending clevises 31. The clip 30 defines mutually perpendicular longitudinal, transverse and lateral axes LA, TA, AA which in turn define mutually perpendicular longitudinal, transverse and lateral directions and mutually perpendicular longitudinal, transverse and lateral planes. The clip 30 is a device which substantially holds the flight control surfaces 25 in the neutral position.

The bowtie 33 and outboard clevises 31 are sufficiently structurally rigid to form a spine 37 which resists bending about any of the mutually perpendicular longitudinal, transverse and lateral axes LA, TA, AA and particularly the longitudinal axis LA. The central bowtie 33 and clevises 31 can be a single integral structure, or structurally joined together from two, three or more separable parts.

The clip 30, and particularly the bowtie 33 thereof, is removably and temporarily insertable between the wing 21 and flight control surface 25, particularly the proximal end thereof, of an aircraft 20 to prevent the aforementioned drooping of the flight control surface 25. The rigidity of the spine 37 should be sufficient to substantially align the flight control surface 25 with the wing 21 and prevent drooping of the particular flight control surface 25 under consideration. The clip 30 is held in place by friction/pressure against the wing 21 and flight control surface 25. This engagement advantageously and unexpectedly obviates the need for separate attachment means such as threaded fasteners, clamps, adhesive, etc. to hold the clip 30 in place during use. Avoiding separate attachment means reduces maintenance time and minimizes damage to the aircraft 20.

The clip 30 may be symmetric about the lateral axis AA. This symmetry provides the benefit that either end 34 of the clip 30 may be used to engage the flight control surface 25 or the wing 21, thereby simplifying maintenance procedures. Likewise, the clip 30 may be symmetric about the transverse axis TA. This symmetry provides the benefit that the clip 30 can be installed either upside down or right side up, further simplifying maintenance procedures. Likewise the clip 30 may be symmetric about the longitudinal axis LA. This symmetry provides the benefit that either face 38 may be oriented towards the user during installation and removal, so that indicia on either face 38 can be seen by the user. Preferably, the clip 30 is symmetric about all of the longitudinal, transverse and lateral axes LA, TA, AA to take advantage of each of these benefits.

The bowtie 33 has a center post 33P and a pair of longitudinally opposed arms 33A extending outwardly therefrom in the longitudinal direction. The center post 33P is preferably coincident the lateral axis AA. The bowtie 33 is preferably symmetric about the lateral axis AA for ease of assembly. The arms 33A of the bowtie 33 diverge in the lateral direction from a proximal end 33AP at the center post 33P to opposed distal ends 33AD. Such divergence resists detachment of the bowtie 33 from a clevis 31 in both the longitudinal and lateral directions.

The center post 33P may have a shorter dimension in the lateral direction than the adjacent lateral dimension between the arms 31A of the clevises 31. This geometry provides the benefit of a more failsafe geometry and holding force utilizing a dove tail mechanical connection, which provides us with the spine 37 resistance to bending about the longitudinal axis LA and resistance to tension in the longitudinal direction. The difference in lateral dimension between the clevis 31 arms 31A and center post 33P is preferably less than the width of the center post 33P.

The bowtie 33 and a clevis 31 may have generally identical overall dimensions in the longitudinal direction. This geometry provides the benefit of allowing slight concave downward blowing of the clip 30 for absorbing torque caused by gravity influence on the flight control surface. A clip 30 having an aspect ratio of 7 in the plane of the mutually identical clevises 31 and the bowtie 33 has been found suitable. Prophetically such an aspect ratio ranging from 6 to 8 would be suitable. A clip 30 having a thickness of 15% of the overall longitudinal dimension has been found suitable. Prophetically a clip 30 having such a thickness ranging from 10% to 20% of the longitudinal dimension would be suitable.

Each clevis 31 comprises a pair of legs 32 extending outwardly from a common proximal end 32P. The legs 32 of one clevis 31 extend in longitudinally opposite directions from the legs 32 other clevis 31 and extend outwardly from the lateral axis AA. The free ends 34 of the legs 32 define the corresponding distal end 34 of the clevis 31. The clevises 31 may be mutually identical for simplicity of manufacture and use.

The legs 32 define an open notch 35 therebetween. The notch 35 may diverge outwardly towards the free ends 34 of the legs 32 and the distal end 34 of the spine 37. This geometry provides the benefit that the notch 35 is wider at the open end, to more easily be inserted onto the wing 21 and the flight control surface 25. As the notch 35 converges towards the proximal end 32P of the legs 32, a tighter fit onto the wing 21 or flight control surface 25 occurs.

Opposite the legs 32 of the notch 35 is an opening 35G complementary to and configured to receive an arm 33A of the bowtie 33. The opening 35G is defined between two clevis 31 arms 31A. The opening 35G diverges towards the notch 35 and converges towards the center post 33P to resist unintended longitudinal separation of the clevis 31 and bowtie 33. The clevis 31 may be symmetric about the longitudinal axis LA. This arrangement provides the benefit that the bowtie 33 and clevises 31 are interlocking into a unitary spine 37 without requiring hand tools such as sockets, ratchets, screw drivers, wrenches, pliers, etc.

A clip 30, and attendant spine 37, comprising three joinably separable parts 31, 33 is preferred for ease of removal from the aircraft 20. Particularly, over time the clip 30 may become wedged onto the wing 21 of the aircraft 20. If so, the maintainer may use a dead blow hammer to strike the clip 30, particularly the bowtie 33 thereof, to separate the bowtie 33 from the clevises 31 to effect removal of the clip 30 without damage to the wing 21.

The three parts 31, 33 may be joined together by insertably removable pins 39. The pins 39 have a shank which is insertable into a complementary hole 39H and a head joined thereto. The head is not insertable into the complementary hole 39H. The head is sized to be grasped by a user for manual insertion of the pin 39 into and removal of the pin 39 from a complementary hole 39H.

The complementary holes 39H may extend through one side of the clevis 31 and into the arm 33A of the bowtie 33. The hole 39H in the arm 33A of the bowtie 33 may be a blind hole 39H or a through hole 39H. If a through hole 39H is used, the hole 39H may further extend into the other arm 31A to receive the pin 39 therein. The pins 39 and complementary holes 39H may be parallel to the lateral axis AA or skewed relative thereto. The pins 39 and holes 39H may be mutually identical for interchangeability and simplicity of manufacture.

The clip 30 is preferably generally planar for convenience of flat pack storage. A planar clip 30 may have transversely opposed and parallel faces 38 defining a width therebetween. A constant width provides the benefit of flat pack storage. The width may increase in the lateral direction as the distal end 34 of the clevis 31 is approached to offset the deflection of the legs 32. This geometry provides the benefit of ergonomics.

The bowtie 33, clevises 31 and pins 39 may be provided as a kit 40. The kit 40 may include plural bowties 33 to accommodate different sized gaps between the wings 21 and flight control surfaces 25 of various aircraft 20. The kit 40 may include identical and different clevises 31, for tailoring to a specific flight control surface 25 of a specific aircraft 20. The kit 40 may be placed in a container for protection, transport and storage.

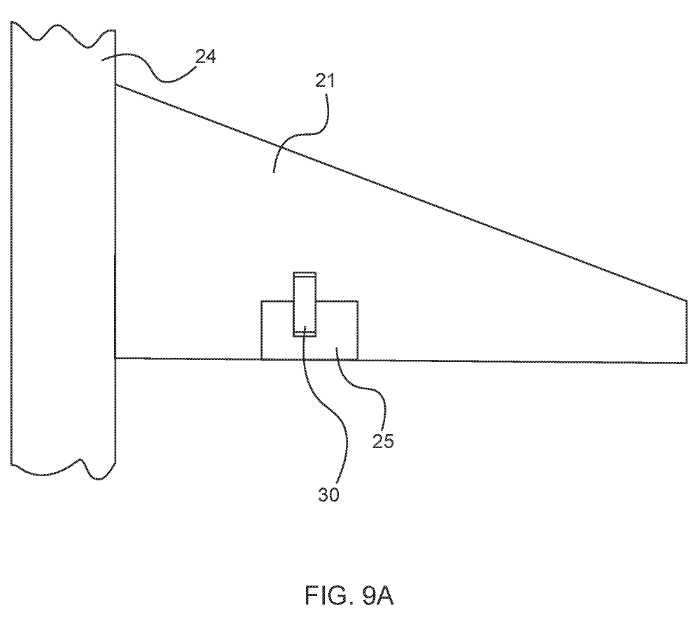

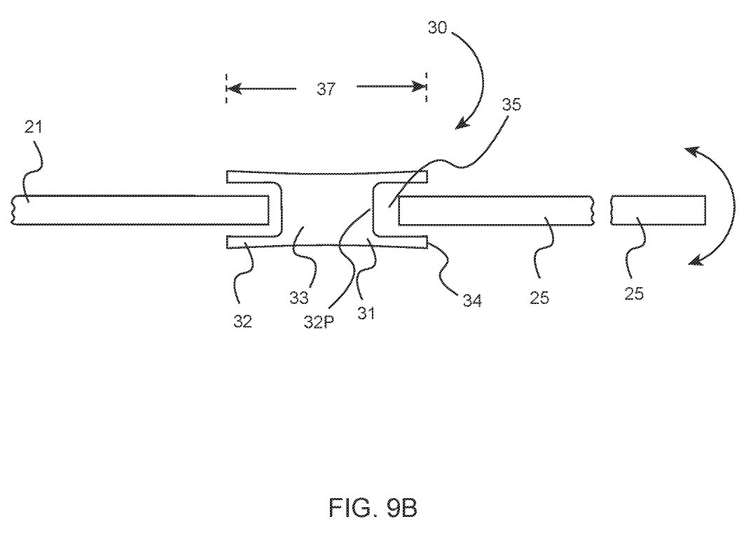

Referring to FIGS. 9A and 9B, a single-piece clip 30 having an integral, optionally homogenous and monolithic, construction is shown while in use on aircraft 20. The notch 35 of one clevis 31 removably receives a wing 21 therein while the other notch 35 removably receives a flight control surface 25, and particularly the proximal end thereof, therein. While a single clip 30 is shown in use, one of skill will understand that a heavier flight control surface 25 and less rigid spine 37 may require plural clips 30 to prevent drooping.

The clip 30 may be made of acrylonitrile styrene acrylate (ASA). ASA is an amorphous thermoplastic, particularly an acrylate rubber-modified styrene acrylonitrile copolymer. In ASA spherical particles of slightly crosslinked acrylate rubber function as an impact modifier when chemically grafted with styrene-acrylonitrile copolymer chains, and embedded in a styrene-acrylonitrile matrix. ASA has high outdoor weatherability, good antistatic properties and retains gloss, color, and mechanical properties in outdoor exposure. ASA is compliant to thereby minimize damage to the aircraft 20 and injury to personnel

In use, the maintainer may be provided with a clip 30 of the dimensions for the particular aircraft 20 under consideration. The clip 30 is either a unitary assembly or is assembled so that the bowtie 33 fixedly disposed between the two clevises 31. The maintainer then inserts the clip 30 into the gap between the static portion of the wing 21 and the flight control surface 25, beginning at the distal end of the wing 21. The maintainer then slides the clip into the gap and towards the fuselage 24 and proximal end of the wing 21. As the gap between the static portion of the wing 21 and flight control surface 25 narrowingly tapers the clip 30 will wedge into at a position which provides for secure frictional engagement. The maintenance may then safely begin.

While the clip 30 of the present invention may allow for some deviation of the flight control surface 25 from coplanarity with the wing 21, such deviation is minimal, does not functionally interfere with aircraft 20 maintenance, does not present a personnel hazard and is not considered droop. The clip 30 and spine 37 of the present invention advantageously has no moving parts, requires no external power supply, can be frictionally attached to and removed from the aircraft 20 and can be attached to and removed from the aircraft 20 without hand tools such as a wrench, screwdriver, socket or pliers.

All values disclosed herein are not strictly limited to the exact numerical values recited. Unless otherwise specified, each such dimension is intended to mean both the recited value and a functionally equivalent range surrounding that value. For example, a dimension disclosed as "40 mm" is intended to mean "about 40 mm." The term "or" as used herein is to be interpreted as an inclusive or meaning any one or any combination. Therefore, "A, B or C" means "any of the following: A; B; C; A and B; A and C; B and C; A, B and C." Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v.A WH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A clip for holding a flight control surface in a neutral position, the clip defining mutually perpendicular longitudinal, transverse and lateral axes and comprising:
a spine having mutually opposed faces a longitudinal axis with mutually opposed and longitudinally spaced distal ends;
mutually opposed notches with each distal end having a notch therein, each notch intercepting a respective distal end and extending from the first face to the second space; and
a bowtie intermediate and separating the longitudinally opposed notches.

2. A clip according to claim 1 made of homogenous, compliant material.

3. A clip according to claim 2 which is symmetric about the transverse axis.

4. A clip according to claim 3 wherein each notch diverges outwardly as the distal end is approached.

5. A clip according to claim 1 having constant width in a transverse direction.

6. A multi-part clip for holding a flight control surface in a neutral position, the clip defining mutually perpendicular longitudinal, transverse and lateral axes and comprising:
a spine having mutually opposed faces a longitudinal axis with mutually opposed and longitudinally spaced distal ends;
mutually opposed notches with each distal end having a notch therein, each notch intercepting a respective distal end and extending from the first face to the second space; and
a bowtie intermediate and separating the longitudinally opposed notches, the clip being easily separable into plural distinct parts.

7. A clip according to claim 6 which is separable into three independent parts, the parts comprising a central bowtie and two clevises configured to extend longitudinally outward therefrom, each clevis having a leg longitudinally extending from a proximal end to the distal end of the clip.

8. A clip according to claim 7 wherein the three parts are removably joinable together by two pins, each pin being adapted to be removably inserted, in turn, through a first leg of the clevis and into the bowtie.

9. A clip according to claim 8 wherein the three parts are removably joinable together by two pins, each pin being adapted to be removably inserted, in turn, through a first leg of the clevis, through the bowtie and into a second leg of the clevis.

10. A clip according to claim 8 wherein the pin comprising a head and a shank joined thereto, the head of the pin adapted to be grasped by a user for manual insertion into and removal from the three parts.

11. A clip according to claim 7 wherein the two clevises are mutually identical.

12. A clip according to claim 7 symmetric about the longitudinal axis and wherein the clevises have a clevis lateral dimension and the bowtie has a bowtie lateral dimension, the clevis lateral dimension and the bowtie lateral dimension
being parallel to the mutually opposed faces, the clevis lateral dimension being greater than the bowtie lateral dimension.

13. A clip according to claim 12 wherein the difference between the clevis lateral dimension and the bowtie lateral dimension is less than the longitudinal separation between the clevises when the three pieces of the clip are assembled for use.

14. A clip according to claim 6 wherein the legs of each clevis diverge outwardly.

15. A kit for temporarily aligning a flight control surface on a wing of an aircraft, the kit comprising:
first and second mutually identical clevises, each clevis comprising two legs extending outwardly from a proximal end to laterally spaced apart legs distal ends, defining respective longitudinally spaced apart clip distal ends, each clevis having a laterally extending hole through at least one leg;
a bowtie configured to be received into the legs of each clevis and juxtaposed with the proximal end the respective clevis; and
a pair of mutually identical pins, each pin having a shank sized to fit into the hole of a clevis and a head joined thereto sized to prevent insertion into the hole of a clevis.

16. A kit according to claim 15 wherein the mutually identical clevises and the bowtie have mutually identical lengths in a longitudinal dimension.

17. A kit according to claim 16 wherein the mutually identical clevises and the bowtie are generally planar.

18. A kit according to claim 17 wherein the kit, when assembled into a clip, has an aspect ratio ranging from 6 to 8 in the plane of the mutually identical clevises and the bowtie.

19. A kit according to claim 18 wherein the kit, when assembled into a clip, has a thickness ranging from 10% to 20% of the longitudinal dimension thereof.

20. A kit according to claim 19 wherein the kit, when assembled into a clip, has a constant thickness in a transverse dimension.
